(19) United States
(12) Patent Application Publication
(10) Pub. No.: US 2011/0078801 A1
(43) Pub. Date: Mar. 31, 2011

(54) UTILITY COMPUTING WITH PREVIEW AND PAY FEATURE

(75) Inventor: Seockhoon Bae, Palo Alto, CA (US)

(73) Assignee: RAPIDFORM, INC., Sunnyvale, CA (US)

(21) Appl. No.: 12/569,132

(22) Filed: Sep. 29, 2009

(51) Int. Cl. G06F 15/16; G06F 21/00; G06F 3/048; G06Q 50/00; G06Q 99/00; G06Q 30/00; G06F 17/30

(52) U.S. Cl. 726/29; 715/738; 705/34; 715/733; 707/E17.009; 705/1.1; 705/39

(57) ABSTRACT

A remote computing service is provided that allows a user to preview results of processing at a remote computing device on a client device before committing to pay for and download result data. The remote computing device derives a series of preview data sets from the result data processed at the remote computing devices. The client device receives the preview data sets and presents output to a user for inspection, evaluation or examination of various aspects of the result data. By allowing the user to inspect, evaluate or examine the result data based on the series of preview data sets, there are fewer occasions where the user needs to download the result data that may have a large size to the client device. Further, the series of preview data sets is structured so that the result data cannot be reconstructed by harvesting the series of preview data sets. Hence, the user cannot take advantage of the preview data to reconstruct the result data without paying for the result data.

### BACKGROUND

1. Field of Art

The disclosure generally relates to processing data at a remote computing device and making the processed data available to a client device, and more specifically to processing 3D data at a remote computing device with large computing resources and making the processed 3D data available to a thin client device.

2. Description of Art

In utility computing, computation resources such as computation capacity and storage are essentially rented to customers. Instead of purchasing the computational resources, the customers are allotted a certain share of computation resources, typically in return for service fees that increase with the amount of computation resources allotted to the customers. The utility computing is advantageous, among other reasons, because the customers may (i) incur a low or no initial cost to acquire hardware, (ii) avoid technical difficulties associated with assembling and maintaining the computational resources, and (ii) easily and promptly accommodate increased processing demand by renting additional computational resources. Such advantages have contributed to wide adoption of utility computing in fields such as Internet hosting services.

In addition to hardware resources, some fields of computation processing require specialized software products to accomplish a desired result. Such software products may be included in the utility computing services as part of a basic service or an added-on service. Some software components, however, are not amenable to utility computing because application developers may impose a strict licensing scheme that restricts use of the software products in utility computing environment. The application developers may want to generate more revenue from selling copies of the software products to individual users or companies instead of providing the service as part of a bundled utility computing service out of fear that the utility computing service may erode profitable sale of the software product copies.

Further, in some fields of computer processing, utility computing may require too much data traffic between a local client device and a remote computing device providing the utility computing service. The increased data traffic may cause delay in overall process of processing the data using utility computing. For example, 3D data associated with 3D operations such as 3D data processing, 3D image rendering and 3D modeling typically take up dozens or hundreds of megabytes. Hence, it may take a large amount of time to download or upload the 3D data for processing at the remote computing device. Such extensive downloading time may hinder wider adoption of utility computing in certain fields of large sized data processing.

This issue associated with delay in communicating large sized data is exacerbated if multiple steps of processing is required and user intervention is needed at each processing step. In order to proceed to the next processing step, a user may need to perform manual corrections and/or set parameters for subsequent processing. For this purpose, data processed at the remote computing device is downloaded onto the local client device for inspection, examination or evaluation by the user at the local client device. Then the user must provide requisite processing parameters and sometime upload the modified data to the remote computing device for further processing. The increased data associated with user intervention, inspection, examination or evaluation further deteriorates efficiency of the utility computing.

### SUMMARY

Embodiments provide a method, a computing device, and a computer readable storage medium for processing a first data item into a second data item at a first computing device and sending a series of preview data sets derived from the second data item to a second computing device. The second computing device may present the series of preview data sets to a user for inspection, evaluation or examination of the second data item. The user sends commitment to pay for the second data item after inspecting, evaluating or examining the second data item based on the series of preview data sets. After the user commits to pay for the second data item, the second data item is made available to the user for downloading, sharing or further processing.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 is a system diagram of a remote processing system according to one embodiment.

FIG. 2 is a block diagram illustrating a client device according to one embodiment.

FIG. 3A is a block diagram illustrating hardware components in a remote computing device according to one embodiment.

FIG. 3B is a block diagram illustrating software components in a remote computing device, according to one embodiment.

FIG. 4 is an interaction diagram illustrating a process of providing remote computing services, according to one embodiment.

FIG. 5 is a flowchart illustrating a process of generating preview data, according to one embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Embodiments relate to providing a remote computing service that allows a user to preview results of processing at a remote computing device on a client device before committing to pay for and download result data. The remote computing device derives a series of preview data sets from the result data processed at the remote computing devices. The client device receives the preview data sets and presents output to a user for inspection, evaluation or examination of various aspects of the result data. By allowing the user to inspect, evaluate or examine the result data based on the series of preview data sets, there are fewer occasions where the user needs to download the result data that may have a large size. Further, the series of preview data sets is structured so that the result data cannot be reconstructed from the series of preview data sets. Hence, the user cannot take advantage of the preview data to reconstruct the result data without paying for the result data.

Result data described herein refers to information obtained by executing an application on a remote computing device. Computer resources including software products are required to obtain the result data at the remote computing device. An example of the result data represents 3D geometry and its topology of a 3D object.

Preview data described herein refer to information derived from processed data to allow a user to inspect, examine or evaluate the result data. The preview data have decreased size compared to the processed data, and hence, take up less time and bandwidth for communication from a remote computing device to a client device. The preview data is structured so that the result data cannot be reconstructed from the preview data. An example of preview data is raster 2D images projected from a 3D data representing a 3D object.

### Example Architecture of Remote Computing System

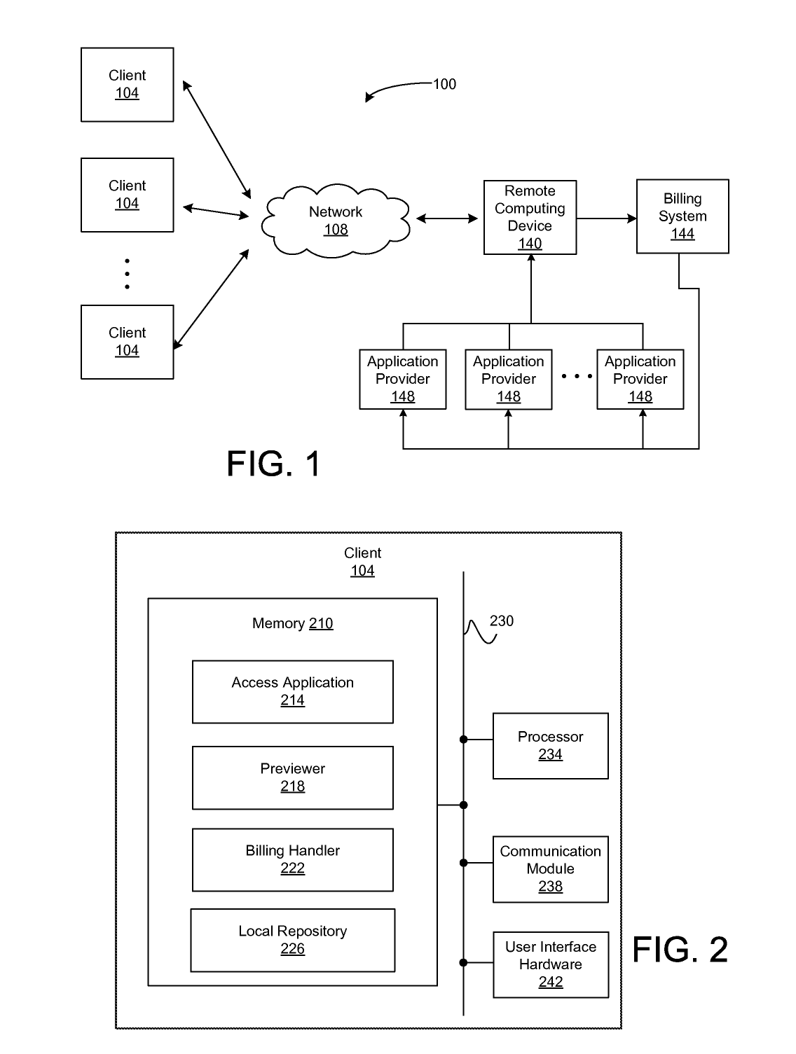

FIG. 1 is a system diagram of a remote processing system 100, according to one embodiment. The remote processing system 100 may include, among other components, a plurality of client devices 104, a network 108, a remote computing device 140, and a billing system 144. The client devices 104 access the network 108 via a wireless or wired network 104 to the remote computing device 140. The remote computing device 140 communicates with the billing system 144 via a communication channel that may include the network 108. The remote computing device 140 may also communicate with the application providers 148 to load and store applications. The billing system 144 also communicates with the application providers 148 to distribute fees associated with using the applications.

The remote processing system 100 may include additional components not illustrated in FIG. 1 to support the remote computing service. Also, some components of the remote processing system 100 may be combined with other components. For example, the billing system 144 may be combined with the remote computing device 140. Further, one or more components of the remote processing system 100 may include multiple physical or virtual devices. For example, the remote computing device 140 may include multiple servers, each server performing identical or dedicated operations.

The remote processing system 100 adopts a scheme similar to utility computing. Specifically, users are charged with fees for processing data at the remote computing device 140. Responsive to receiving a request from a user, the remote computing device 140 executes one or more applications to process data and generate the result data. In one embodiment, the user is charged based on one or more of the following factors: (i) the number and type of applications executed, (ii) the size of data being processed, (iii) the size of the result data, (iv) computing time spent in processing the data, and (v) the quality level (e.g., resolution) of the result data as requested by the user. The size of data can be measured by several different ways. It can be the file size in bytes, the number of entries stored in data, or other commonly used metrics in the application domain. By using such a scheme, the user may reduce the cost, time and efforts associated with purchasing applications and/or hardware equipments for data processing and setting up the applications and hardware devices.

Further, the remote processing system 100 reduces the data communicated between the client devices 104 and the remote computing devices 140 by allowing the users to inspect, examine or evaluate the processed result data on the client devices 104 without downloading the result data to the client devices 104. Specifically, the remote processing system 100 provides preview data derived from the result data to the client devices 104 for the users' access. The sharing of the result data via the remote computing device 140 through identification information (e.g., hypertext link) of the result data also reduces the amount of data communicated between the client devices 104 and the remote computing device 140. In this way, the remote processing system 100 makes data processing involving large amounts of data more efficient and convenient.

The client devices 104 are computing devices that interact with users. The client devices 104 communicate with the remote computing device 140 via the network 108 to perform operations on the remote computing device 140 and receive the preview data from the remote computing device 140. In one embodiment, the client devices 104 are thin client devices having restrained computing resources insufficient to perform heavy computing to generate the result data. The client devices 104 may be a general purpose computing device capable of performing various types of operations or a special purpose computing device designed for remote processing. Example client devices 104 include laptop computers, desktop computers, mobile computing devices (e.g., smartphones), game consoles, and multimedia players (e.g., personal media player). An example structure of the client devices 104 is described below in detail with reference to FIG. 2.

The network 108 is a combination of network components for communicating data between the client devices 104 and the remote computing device 140. The network 108 may include, among others, Internet. The network 108 may employ one or more communication protocols to communicate data between the client devices 104 and the remote computing devices 140. Although the application providers 148 and the billing system 144 are illustrated as communicating with the remote computing device 140 directly, these components of the remote processing system 100 may also communicate via the network 108.

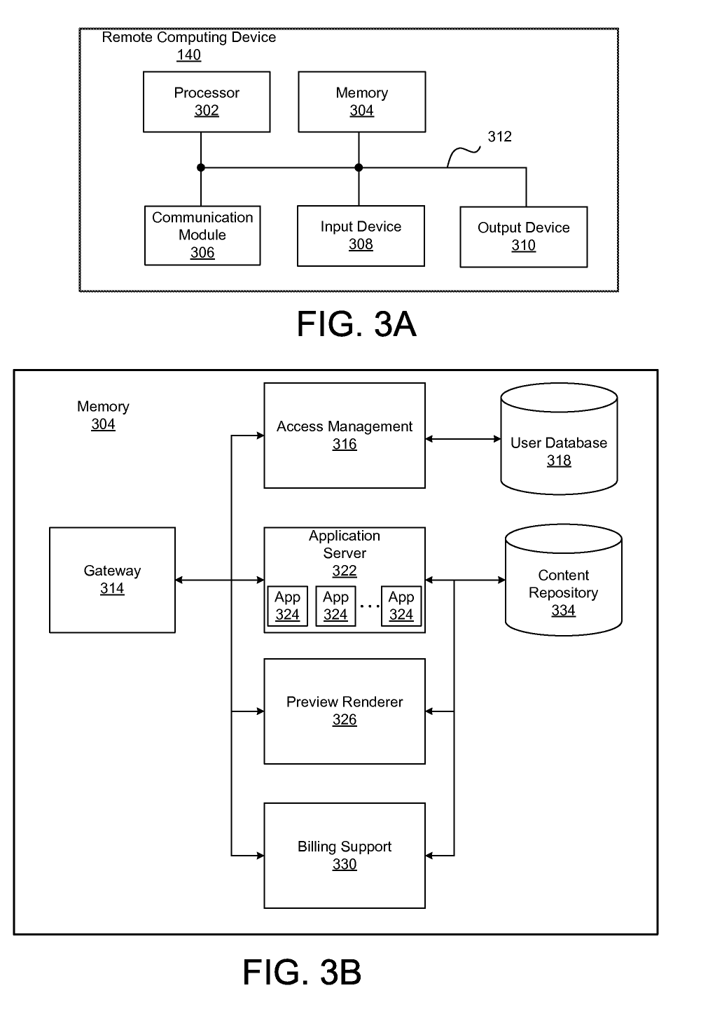

The remote computing device 140 is one or more computing devices capable of performing computing operations to generate the result data pursuant to the user's demand. In one embodiment, the remote computing device 140 is capable or performing heavy computation associated with 3D data using at least one application. The remote computing device 140 may also authenticate the user, generate preview data of the result data, and support billing operations, as described below in detail with reference to FIG. 3B. Note that the term ‘remote’ used herein does not imply that the remote computing device 140 must be located geographically distant from the client devices 104. Rather, the term ‘remote’ indicates that the remote computing device 140 is separate from the client devices 104, and hence, data must be communicated to or from the client devices 104 via the network 108.

The billing system 144 communicates with the remote computing device 140 to charge fees to the users using the remote computing device 140. In one embodiment, the billing system 144 is a credit card billing system or an online baking system that allows the remote computing device 140 to charge the users for fees. In one embodiment, the billing system 144 automatically determines distribution of earned fees between a party operating the remote computing device 140 and application providers 148 who develop applications for deployment on the remote computing device 140.

The application providers 148 develop applications that can be deployed on the remote computing device 140. The remote computing device 140 may provide a centralized application shop or store that allows a user to search, select and execute applications on the remote computing device 140. In one embodiment, each application provider 148 is given the authority to choose and implement payment schemes for using his applications. The payment scheme may include, among others, pay per processing of data, balancing pre-paid deposit, monthly or annual subscription fee for unlimited use of the applications within the subscription period, and fees based on the size of data being processed. In one embodiment, the application providers 148 are responsible for updating and maintaining the applications executed on the remote computing device 140. Further, the application providers 148 may enable or disable certain features of the applications. By giving more control over various aspects of the remote processing system 100 and payment schemes to the application providers 148, more application providers 148 can be attracted to post and make their applications available through the remote processing system 100.

### Result Data and Preview Data

The preview data is generated at the remote computing device 140 and sent to the client devices 104 to present output to the users. The preview data may have one or more of the following characteristics: (i) the preview data includes less amount of information compared to the result data, (ii) the preview data represents data of lower dimension (e.g., 2D) compared to the result data (e.g., 3D), (iii) the preview data requires less processing to render an output or manipulate on the client devices 104, and (iv) a collective set of preview data allows the user to inspect, examine or evaluate the result data at a detailed level as if the result data was downloaded and accessed by a related application on the client devices 104.

By including less data in the preview data compared to the result data, the preview data can be transmitted to the client device 104 in a shorter time. When multiple users are involved in a collaborative activity associated with the result data or frequent user intervention is required after each step of processing, the reduced transmission time of data by transmitting the preview data instead of the result data may yield significant improvement in work efficiency. In one embodiment, the information absent from the preview data represents salient features of the result data. For example, the result data may be a music file and the preview data may be modified version of the music file filtered to remove frequency components of a singer's voice.

The reduced dimension of the preview data compared to the result data may be viewed as one way of reducing the amount of data associated with the preview data. Further, the reduced dimension of the preview data may also contribute to the reduced processing to render an output or manipulate the data on the client device 104. One way of reducing the dimension in the preview data is by removing data associated with a spatial dimension of the result data. For example, depth information may be removed from 3D data (result data) to obtain 2D image data (preview data). Alternatively, data associated with dimension other than the spatial dimension may be removed from the result data to obtain the preview data. For example, time information may be removed from a sequence of images (result data) to obtain still image frames (preview data).

In one embodiment, the preview data allows the user to inspect, evaluate or examine the result data without degraded quality or resolution. The preview data may be generated in response to preview parameters received from the client devices 104. By manipulating or setting the preview parameters, the user can analyze various aspects of the result data extensively before committing to pay for the result data.

In one embodiment, the information lacking from the preview data makes it impossible or impractical to reconstruct the result data from the preview data. In the example where the result data are 3D data representing a 3D object and the preview data are 2D image data, the lack of data associated with a spatial dimension (e.g., depth data) in the 2D data would make reconstruction of 3D data impossible. The difficulty associated with reconstructing the result data from the preview data would leave no choice but to purchase the result data for downloading, sharing or further processing by the users. In this way, the application providers 148 can rest assured that the fees for using their applications will be duly collected and distributed without the risk that the user will harvest the preview data and reconstruct the result data. Contrast this with a scenario where OpenGL or Direct3D codes are sent from the remote computing device 140 for the user to inspect, examine or evaluate 3D result data at the client devices 104. In this scenario, a clever user may capture the OpenGL or Direct3D rendering commands and reconstruct the 3D result data from these codes. This allows the user to avoid paying for processing of the 3D result data, and take advantage of the remote processing system 100.

In the following, embodiments are primarily described using an example where the preview data are 2D data and the result data are 3D data. This is merely for the purpose of explanation. Data representing various other physical properties and subject to various other processing may be used as the preview data or the result data.

### Example Architecture of Client Device

FIG. 2 is a block diagram illustrating the client device 104 according to one embodiment. The client device 104 interacts with a user to send data such as processing parameters and billing information to the remote computing device 140. The client device 104 also receives data such as the result data from the remote computing device 140. In one embodiment, the client device 104 includes, among other components, a memory module 210, a processor 234, a communication module 238, a user interface module 242, and a bus 230 connecting these components. The client device 104 illustrated in FIG. 2 is merely illustrative.

The processor 234 reads instructions from the memory 210 to perform various operations including, among others, generating and sending processing parameters based on user inputs, rendering user interface images on a screen (not shown) of the client device 104. Two or more processors may be used to expand the processing capability of the client device 104.

The communication module 238 is hardware, firmware, software or a combination thereof for communicating with the remote computing device 140 over the network 108. The communication module 238 may include, for example, a network card and firmware or software for implementing communication protocols to exchange data over the network 108.

The user interface hardware 242 is a combination of input devices and output devices for receiving user input or presenting outputs to the user. The user interface hardware 242 may include, for example, a screen, a keyboard, a mouse, a webcam, and a speaker.

The memory module 210 is a computer readable storage medium that stores instructions and data. The memory 130 may be specially constructed for the required purposes or it may be a general-purpose computer readable storage device. The memory module 210 includes, and is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions. In one embodiment, the memory module 210 includes an access application 214, a previewer 218, a billing handler 222, and a local repository 226. In one embodiment, the memory module 210 is part of the same integrated circuit that also includes the processor 234.

The access application 214 allows the user to send data to the remote computing device 140 and receive data from the remote computing device 140. In one embodiment, the access application 214 is embodied as a web browser. In another embodiment, the access application 214 is embodied as a software application, which can be a standalone application or an add-on running inside other standalone software, dedicated to communicating with the remote computing device 140.

The previewer 218 receives preview data from the remote computing device 140 and presents the preview data to the user for inspection, evaluation or evaluation. In one embodiment, the previewer 218 is a thin and simple application that performs processing less intensive than the applications executed on the remote computing device 140. For this purpose, the preview data received at the previewer 218 may be in a data format that requires minimal processing at the previewer 218 to generate an output through the user interface hardware 242. Taking an example of processing 3D data using the remote computing device 140, the preview data may be a rasterized 2D image data representing projection of the 3D image onto a 2D projection plane corresponding to a view port. In this example, the previewer 218 is a simple 2D image viewer that receives the 2D image data (preview data) and renders a 2D image for display on the viewport rendered on the screen of the client device 104. The previewer 218 may also operate in conjunction with the access application 214 to send preview parameters (e.g., tilt, pan, zoom and position of the viewport) to the remote computing device 140. The remote computing device 140 generates the preview data according to the received preview parameters and sends the preview data to the previewer 218. In one embodiment, updated preview data are received in real time from the remote computing device 140 as updated parameters are generated and sent from the client device 104. When available, the minimal processing of the preview data at the previewer 218 advantageously allows outputs to be generated at the user interface hardware 242 in real time.

In one embodiment, the previewer 218 in conjunction with the access application 214 simulates presence of the result data in the client device 104. A user can interactively change preview parameters for generating the preview data at the remote computing device 140 by operating the user interface hardware 242 (e.g., moving a mouse). By providing different preview parameters to the remote computing device 140 via the client device 104, the user can inspect, examine or evaluate various aspects of the result data. In the example of 3D data, the client device 104 can simulate panning, rotating, moving and zooming of a 3D object, or walking through a 3D scene by sending a series of preview parameter sets and receiving a series of preview data sets in return. The resolution or quality of the 2D images is controllable and depending on the user configuration, the resolution or quality of the 2D images may be identical or substantially identical to the case where the 3D data are stored locally and rendered by the client device 104. In this way, the users may be assured of the quality of the processing performed at the remote computing device 140 before committing to pay for the result data.

In one embodiment, the previewer 218 is a general purpose application not specifically designed for the remote processing system 100. This obviates the need to develop and deploy additional applications to take advantage of the remote computing device 140.

The billing handler 222 operates in conjunction with the access application 214 to send billing approval and other transactional data needed to pay or commit to payment of the result data. In one embodiment, the billing handler 222 utilizes encryption and anti-hacking measures to prevent illegal approaches to the users' sensitive financial information (e.g., credit card information).

In one embodiment, the previewer 218 and the billing handler 222 are embodied as plug-ins for the access application 214. Alternatively, the previewer 218 and the billing handler 222 may be embodied as stand-alone applications that are capable of performing operations without the support of the access application 214.

The local repository 226 may store, among others, data for uploading to the remote computing device 140 or the result data received from the remote computing device 140. The user may choose to minimize the data stored in the local repository 226 by performing most of the processing at the remote computing device 140. The user may selectively download the resulting data and store the resulting data in the local repository 226 to save the available storage space in the local repository 226.

Although the access application 214, the previewer 218, the billing handler 222 and the local repository 226 are described above with reference to FIG. 2 as being embodied in software, these components may also be embodied as firmware, hardware or a combination of firmware, hardware and software. Further, two or more of these modules can be combined into a single module or subdivided into multiple modules. Also, some of the components in the client device 104 may be embodied in a computing device separate from the client device 104.

### Example Architecture of Remote Computing Device

FIG. 3A is a block diagram illustrating the remote computing device 140 according to one embodiment. The remote computing device 140 may include, among other components, a processor 302, memory 304, a communication module 306, an input device 308 and an output device 310. The remote computing device 140 of FIG. 3A is merely illustrative. The remote computing device 140 may include various other components or omit some components (e.g., the output device 310) illustrated in FIG. 3A.

The processor 302 reads instructions from the memory 304 and performs operations such as processing 3D data. In order to accommodate a plurality of users and heavy computation demands, two or more processors may be provided in the remote computing device 140.

The memory 304 is a computer readable storage medium that stores instructions and data. The memory 304 may be specially constructed for the required purposes or it may be a general-purpose computer readable storage devices. The memory 304 includes, and is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions. The memory 304 may store a plurality of code modules, as described below in detail with reference to FIG. 3B.

The communication module 238 is hardware, firmware, software or a combination thereof for communicating with the client devices 104 and the billing system 144. The communication module 238 may include, for example, a network card and firmware or software for implementing communication protocols to exchange data over the network 108.

The input device 308 receives inputs from the operator of the remote computing device 140. The input device 308 may include, among others, keyboard and mouse.

The output device 310 provides outputs to the operator of the remote computing device 140. The output device 308 may include, among others, a computer screen.

FIG. 3B is a block diagram illustrating software components stored in the memory 304 of the remote computing device 140, according to one embodiment. The memory 304 of the remote computing device 140 may include, among other components, a gateway module 314, an access management module 316, an application server 322, a preview renderer 326, a billing support module 330, a user database 318 and a content repository 334. The software components of FIG. 3B are merely illustrative. The memory 304 may store other software components such as operating systems and middleware to support execution of these components on the remote computing device 140.

The gateway module 314 receives requests from the client devices 104 and sends responses to the client devices 104. The requests may be a HTTP message including data for accessing the remote computing device 140 (e.g., ID and password), parameters associated with the preview data, data for processing, and billing information. The gateway module 314 extracts data from the requests and sends the extracted data to relevant modules. The gateway module 314 may also respond to the requests by sending the preview data, result data, billing transaction information, and other data associated with the remote computing device 140. The response from the gateway module 314 may also be a HTTP message.

The access management module 316 is associated with the user database 318 to control access of users to various resources in the remote computing device 140. In one embodiment, the access management module 316 authenticates the user and allows the user to access content data items associated with the user. The access management module 316 may also facilitate collaborative operations of multiple users on the content data items by supporting group-based user management. Specifically, a group of users may be given access to a content data item. Also, each user may be given different levels of access (e.g., view only, edit allowed and downloading permitted). In case the content data item has a large size, it is advantageous to allow a plurality of users to access the same content data items via links (e.g., hypertext links) or other content identification so that the users can share the content data item without downloading the content data item to their client devices 104. The user database 318 may include, for example, user profiles, billing information and links to accessible content data items for each user.

The application server 322 stores, among others, applications 324 for execution on the remote computing device 140. The applications 324 stored in the application server may be provided by the application providers 148 or other parties (e.g., the operator of the remote computing device 140). In one embodiment, the applications 324 include 3D data processing applications such as XOR/Redesign, XOV/Verifier, XOS/Scan, Rapidform.dll, and InspectWorks available from INUS Technology, Inc. of Seoul, South Korea. In one embodiment, the application server 322 runs multiple operating systems to support applications by virtualization to allow execution of applications developed for different operating system platforms.

The application server 322 may embody a virtual application store where the users can select appropriate applications 324 for processing their data. In one embodiment, the application server 322 may provide additional information such as reviews by other users, price of using the applications, data format compatible with the applications, the number of times the applications were executed, and the ratio that the data resulting from the applications were paid for.

The preview renderer 326 generates preview data from result data. The preview renderer 326 processes the result data, for example, by (i) removing certain information from the result data, (ii) capturing an aspect of the result data or (iii) format conversion. In an embodiment where 3D data is processed using the applications 324, the preview renderer 326 includes a 2D image renderer that generates a rasterized 2D image by projecting a 3D image onto a projection plane corresponding to a viewport on a screen.

The billing support module 330 manages billing transaction associated with processing data using the remote computing device 140 by communicating with the billing system 144. In one embodiment, after a user commits to pay for the result data, the billing support module 330 sends authorization information to the access management module 316 to permit downloading of the result data, further processing of the result data and/or sharing of the result data by the user.

The content repository 334 stores various data resulting from execution of the applications 324 or data required for processing. In one embodiment, the result data is stored in the content repository 334 for access by the users. The content repository 334 may include data other than the result data that is generated during processing. The remote processing system 100 may also automatically generate identification information (e.g., HTTP link) that allows the client devices 104 to access the result data. Each user may perform different operations based on the same result data or share the result of further processing on the result data by sharing the identification information. In this way, users need not download the result data to their client devices 104 for further operation. In one embodiment, a document management scheme is adopted to manage the collaborative activities based on the data stored in the content repository 334.

Although the gateway 314, the access management 316, the user database 318, the application server 322, the preview renderer 326, the billing support module 330 and the content repository 334 are illustrated in FIG. 3B as being stored in the same memory 304 of the same remote computing device 140, one or more of these components may be stored in different memory modules and/or computing devices. In one embodiment, distributed computing is employed to distribute functions performed by these components in multiple computing devices located at the same premise or different premises. Further, some or all of these components may also be embodied as firmware, hardware or a combination of firmware, hardware and software.

### Process of Providing Remote Computing Services

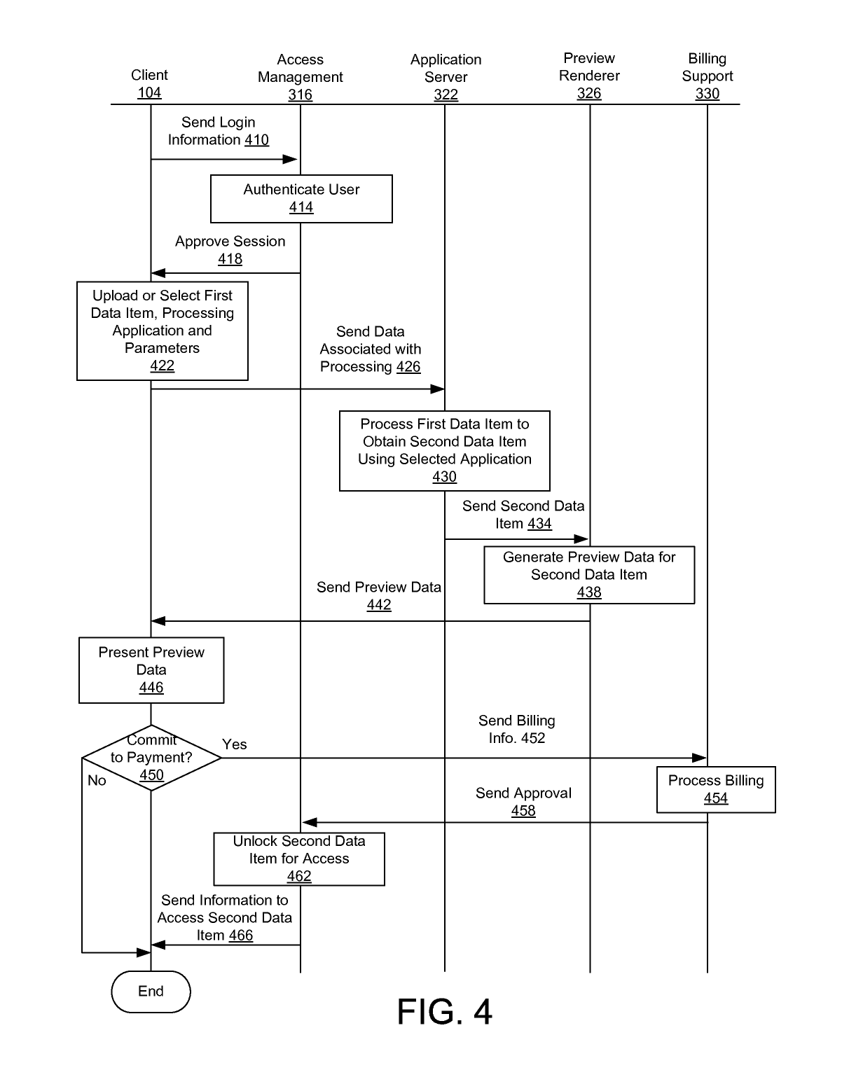

FIG. 4 is an interaction diagram illustrating the process of providing remote computing services, according to one embodiment. A client device 104 sends 410 login information (e.g., ID and password) to the access management module 316. The access management module 316 accesses the user database 318 to authenticate 414 the user. After the user is authenticated, the access management module 314 approves 418 a session to process data and/or preview the processed data on the remote computing device 140.

At the client device 104, a user may (i) upload or select 422 first data item (unprocessed data item), (ii) select applications to process the first data item, and (iii) upload or select parameters associated with processing the first data item using the selected applications. The client 104 then sends 426 data associated with first data item, selection of the applications and processing parameters to the application server 322.

The application server 322 executes the application 324 selected by the user and processes 430 the first data item based on the processing parameters to obtain a second data item (e.g., result data). In one embodiment, an email, a text message, online pop-up notification or any other messages may be sent to the user to indicate that the processing of the first data item is finished and ready for preview. The second data item may be stored in the content repository 334 for access by the preview renderer 326 or be sent 434 directly to the preview renderer 326.

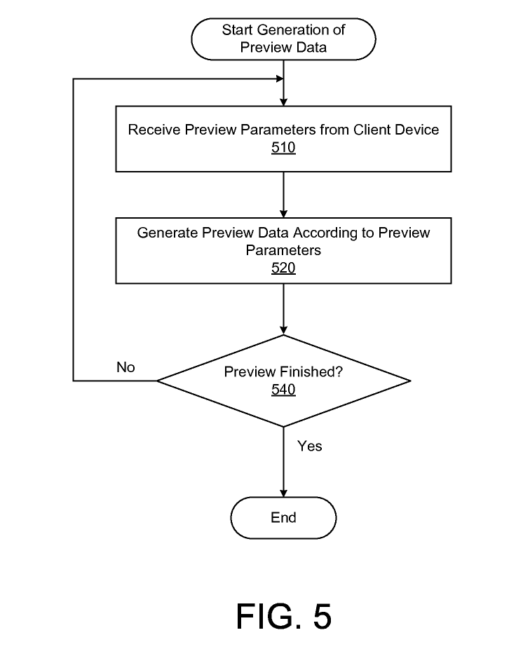

After receiving a request for the preview data from the client device 104, the preview renderer 326 then generates the preview data for the second data item, as described below in detail with reference to FIG. 5. The generated preview data are then sent 442 to the client device 104. The client device 104 receives the preview data and presents 446 the preview data to the user for inspection, evaluation or examination of the second data item.

The user may commit 450 to pay for the second data item anytime the user is confident about the quality or result of the second data item. The unpaid second data item is to be stored for a certain period of time with the download permission locked. In one embodiment, the user or other related parties may preview the second data item as many times as desired. In case that the user opts in a subscription based payment scheme for a pre-selected processing services, the user may be committed for payment automatically without further user input.

If the user does not commit 450 to pay for the second data item, the process terminates without making the second data item available to the user or other related parties.

If the user approves the second data item based on the preview data and decides to commit 450 to the payment of the second data item, the user sends 452 billing information to the billing support module 330 to make payment. The billing support module 330 in conjunction with the billing system 144 processes 454 fees associated with the processing.

After the billing is approved, the billing support module 330 sends approval to the access management module 316. The access management module 316 unlocks the second data item for access by the user. The access management also sends 466 information to the client device 104 that allows the user or other related parties to access the second data item from the remote computing device 140. Then the process terminates.

The process of remotely processing the data as illustrated in FIG. 4 is merely illustrative. Steps such as sending 410, authenticating 414 the user or approving 418 the session may be omitted. Further, other steps in addition to the steps illustrated in FIG. 4 may also be performed.

FIG. 5 is a flowchart illustrating the process of generating preview data, according to one embodiment. First, the preview renderer 326 receives 510 preview parameters from the client device 104. Then the preview renderer 326 generates 520 the preview data according to the received preview parameters.

Then it is determined 540 if the preview is finished. In one embodiment, the preview is finished responsive to receiving user input at the client device 104 indicating the inspection, evaluation or examination of the second data item is finished. In another embodiment, the preview is finished when a set number of preview data sets are sent to the client device 104 or a predetermined amount of time expired after the preview started.

If the preview is not finished, the process returns to receive 510 updated preview parameters and generate 520 the preview data based on the updated preview parameter. In one embodiment, the preview data is generated in real time as the preview parameters are received 510 from client device 104.

By repeatedly generating and sending the preview data in response to receiving the preview parameters, the client device 104 may simulate operations that require presence of the second item data in the client device 104. In the example of 3D data, the preview renderer 326 can generate a series of 2D images sets to simulate moving, panning, rotating and zooming of a 3D object or walking through a 3D scene represented by the 3D data. In one embodiment, the 2D images can have the same high resolution and/or quality as the 2D images that would be generated by executing a 3D application on the client device 104 and loading the second data item onto the 3D application. In this way, the user can inspect, evaluate, and examine the second data item at a detailed level to feel assured that the second data item satisfies the user's demand.

In one embodiment, a series of preview data sets is generated automatically by the preview renderer 326 without receiving any preview parameters from the client device 104. The series of preview data sets reflect various aspects of the second data item to give assurance to the user that the second data item satisfies the user's demand.

In one embodiment, the preview renderer 326 predicts the preview parameters likely to be received from the client device 104. The preview renderer 326 then generates and stores the preview data based on the predicted preview parameters. When the prediction is determined to be correct, then the preview renderer 326 fetches and sends the preview data based on the prediction. In this way, the preview data may be sent more promptly to the client device 104.

Upon reading this disclosure, those of skill in the art will appreciate still additional alternative structural and functional designs for a remote computing service through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for processing data at a first computing device, comprising:
processing a first data item into a second data item by a first application executed on the first computing device;
generating a series of preview data sets derived from the second data item;
sending the series of preview data sets to a second computing device for presentation, the second computing device incapable of reconstructing the second data item from the series of the preview data sets;
receiving commitment to compensate for the second data item responsive to sending the series of preview data sets to the second computing device; and
making the second data item available responsive to receiving the commitment.

2. The method of claim 1, further comprising receiving preview parameters from the second computing devices, the series of the preview data sets generated at the first computing device based on the preview parameters.

3. The method of claim 2, wherein the series of preview data sets allow the second computing device to simulate operations requiring presence of the second data item in the second computing device.

4. The method of claim 1, where in the second data item comprise 3D data representing a 3D object and the preview data comprises 2D image data.

5. The method of claim 1, wherein making the second data item available comprises granting access of the second data item to two or more users.

6. The method of claim 1, further comprising processing the second data item into a third data item by a second application executed on the first computing device responsive to making the second data item available.

7. The method of claim 1, further comprising distributing fees received as compensation to two or more parties including at least one party providing the first application on the first computing device.

8. The method of claim 1, further comprising receiving selection of the first application from a plurality of applications in the first computing device.

9. A first computing device for processing a first data item into a second data item, comprising:
an application server configured to process a first data item into a second data item by a first application executed on the first computing device;
a preview renderer configured to:
generate a series of preview data sets derived from the second data item; and
send the series of preview data sets to a second computing device for presentation, the second computing device incapable of reconstructing the second data item from the series of the preview data sets;
a billing support module configured to receive commitment to compensate for the second data item responsive to sending the series of preview data sets to the second computing device; and
making the second data item available responsive to receiving the commitment.

10. The first computing device of claim 9, wherein the preview renderer is further configured to receive preview parameters from the second computing devices, the series of the preview data sets generated at the first computing device based on the preview parameters.

11. The first computing device of claim 10, wherein the series of preview data sets allow the second computing device to simulate operations requiring presence of the second data item in the second computing device.

12. The first computing device of claim 9, where in the second data item comprise 3D data representing a 3D object and the preview data comprises 2D image data.

13. The first computing device of claim 9, wherein the access management module is configured to make the second data item available by granting access of the second data item to two or more users.

14. The first computing device of claim 9, wherein the application server is further configured to process the second data item into a third data item by a second application executed on the first computing device responsive to making the second data item available.

15. The first computing device of claim 9, wherein the billing support module is further configured to distribute fees received as compensation for the second data item to two or more parties including at least one party providing the first application available on the first computing device.

16. The first computing device of claim 9, further comprising content repository configured to store the second data item.

17. A computer readable storage medium configured to store instructions, the instructions when executed by a processor in a first computing device, cause the processor to:
process a first data item into a second data item by a first application executed on the first computing device;
generate a series of preview data sets derived from the second data item;
send the series of preview data sets to a second computing device for presentation, the second computing device incapable of reconstructing the second data item from the series of the preview data sets;
receive commitment to compensate for the second data item responsive to sending the series of preview data sets to the second computing device; and
make the second data item available responsive to receiving the commitment.

18. The computer readable storage medium of claim 17, further comprising instructions to receive preview parameters from the second computing devices, the series of the preview data sets generated at the first computing device based on the preview parameters.

19. The computer readable storage medium of claim 18, wherein the series of preview data sets allow the second computing device to simulate operations requiring presence of the second data item in the second computing device.

20. The computer readable storage medium of claim 18, where in the second data item comprise 3D data representing a 3D object and the preview data comprises 2D image data.
